(19) United States
(12) Patent Application Publication
(10) Pub. No.: US 2008/0121021 A1
(43) Pub. Date: May 29, 2008

(54) Process and apparatus for inspection of an aircraft jet engine for oil leaks

(75) Inventors: Georg Barke, Hamburg (DE); York Schilling, Hamburg (DE)

Correspondence Address: MORRISON & FOERSTER LLP, 1650 TYSONS BOULEVARD, SUITE 400, MCLEAN, VA, 22102, US

(73) Assignee: Lufthansa Technik AG, Hamburg (DE)

(21) Appl. No.: 11/604,395

(22) Filed: Nov. 27, 2006

(51) Int. Cl. G01M 3/04

(52) U.S. Cl. 73/40

(57) ABSTRACT

A method for checking an aviation jet power plant for oil leaks involves inspecting for oil deposits a secondary airflow which is bled from a compressor of the power plant and may also include measuring the aerosol content of the secondary airflow and determining the numbers of aerosol particles within different size classes, which may include particles with a diameter of between 0.05 μm and 10 μm, preferably between 0.1 μm and 5 μm and more preferably between 0.2 μm and 2 μm. A suitable apparatus for this method includes a device measuring the oil content of the secondary airflow, a connecting device providing a connection to the inside of the compressor, and a gas line installed between the measuring device and the connecting device. The connecting device may be configured for connection to a borescope opening of the power plant.

### FIELD OF THE INVENTION

The invention relates to a method and a device for checking an aviation jet power plant for oil leaks.

### BACKGROUND OF THE INVENTION

In aircraft, the compressed air for the air conditioning system is bled from the power plants. Oil leaks in the power plant can lead to the air which is used for the air conditioning having an oily smell. Since the air conditioning system can be connected to several power plants at the same time it can be difficult to associate the defect with a specific power plant. Up to now, it was customary to dismantle one power plant after the other until the defect was found.

The invention is based on the object of making available a method and a device which enables a detection of oil leaks in the power plant without dismantling of the power plant.

### SUMMARY OF THE INVENTION

The object relating to the method is achieved by checking an aviation jet power plant for oil leaks including inspecting for oil deposits a secondary airflow which is bled from a compressor of the power plant. The method also includes measuring the aerosol content of the secondary airflow and determining the numbers of particles within different size classes. Advantageous embodiments are found in the detailed description below.

According to the invention, a secondary airflow bled from the compressor of the power plant is inspected for oil deposits. The invention has recognized that oil volumes which are carried along by the airflow of the compressor are distributed evenly in the airflow. On this basis, an optional amount of the airflow can be bled as a secondary airflow at any point of the compressor, and can be inspected for oil deposits. From the oil deposits in the secondary airflow, conclusions can be directly drawn regarding the oil deposits in the airflow of the compressor.

Since the airflow in the compressor moves at high speed, the oil deposits are carried along regularly in the form of an aerosol, i.e. in the form of a fine distribution of particles which are suspended in the airflow. The method can be aimed at measuring the aerosol content of the secondary airflow. The determining of the aerosol content can be carried out by means of an aerosol spectrometer. Alternatively, other methods such as mass spectrometry, flame ionization detection, or infrared spectroscopy can be used for determining the content of oil deposits.

In addition to the particles of the oil deposits, the airflow contains additional particles, for example particles of dust which are carried along. The size of these additional particles frequently differs from the size of the particles of the oil deposits. For the distinguishing of the particles, it can be advantageous to define different size classes of particles and to determine the number of particles in the individual size classes. Preferably, the size classes comprise particles with a diameter between 0.05 μm and 10 μm, more preferably between 0.1 μm and 5 μm, more preferably between 0.2 μm and 2 μm. During earlier measurements, the size of the particles was measured in induction air which was contaminated by oil constituents. It was found that the aerosol of the oil deposits contains predominantly particles the size of which lies inside these limits. The method, therefore, is to measure the particles the size of which lies between the smallest size specification and the largest size specification. A classification into a plurality of size classes is undertaken inside the range which is defined by the two size specifications.

The aerosol content can be measured on the basis of the dispersion of white light on particles inside a measuring volume. The use of white light has the advantage that irregularly formed particles are easily recognized. In monochromatic light, the recognition of irregularly formed particles is more liable to error.

Particles of different substances can have different densities. To be able to distinguish different substances, the mass concentration of the particles inside the aerosol can be determined within the scope of the method according to the invention.

The airflow in the compressor of the power plant can be under a pressure of more than 10 bar. The secondary airflow can also be under this pressure if it emanates from the compressor. If the measuring device is not designed for measurements at such a high pressure it can be advantageous to reduce the pressure of the secondary airflow before measuring.

The reducing of the pressure should be carried out so that the content of aerosols which are carried along remains unaltered as far as possible. In conventional pressure reducers, the direction of movement of the gas under pressure is changed many times. On account of the greater mass inertia of the particles of the aerosol, some of the aerosol settles on component parts of the pressure reducer during such changes of direction. In order to avoid this, it can be advantageous to achieve the pressure reduction by discharging some of the secondary airflow to the environment before measuring.

An improved comparability of the measurement results is achieved by the measuring being carried out at constant pressure of the air which is to be tested. During measuring, the pressure lies preferably between 2 bar and 15 bar, more preferably between 5 bar and 10 bar, more preferably between 7 bar and 9 bar.

For the comparability of the measurement results, it is advantageous, furthermore, if the measuring is carried out at a constant volumetric flow rate. The volumetric flow rate lies preferably between 0.5 l/min and 20 l/min, more preferably between 1 l/min and 10 l/min, more preferably between 3 l/min and 7 l/min.

The temperature of the airflow in the compressor can lie above 300° C. The secondary airflow emerges from the compressor at this high temperature. If the measuring device is not designed for measurements at such high temperatures, the temperature of the secondary airflow can be reduced before measuring. For measuring, the temperature of the secondary airflow should lie between 50° and 150°, preferably between 80° and 120°.

The method can be carried out on a power plant test stand, but it can also be carried out with the power plant installed. On the power plant test stand, all auxiliary units which are supplied with compressed air from the airflow of the compressor, such as the air conditioning system, are not connected to the power plant. For normal test runs, the openings which remain after the disconnecting of the connections in the wall of the compressor are closed. For the application of the method, it can be advantageous not to close a connection which is provided for the supply of the air conditioning system, but instead to bleed the secondary airflow through this connection.

With the power plant installed, all auxiliary units are connected to the power plant. The connections which are provided for the supply of the air conditioning system are not simply accessible. In addition to the connections which are provided for the supply of the auxiliary units, borescope openings are provided in the wall of the compressor. These borescope openings are arranged so that they are accessible with the power plant installed, and enable the inspection of the inside of the compressor by means of a borescope. For the application of the method, especially with the power plant installed, such a borescope opening can be used for the bleed of the secondary airflow.

In addition to the power plants for propulsion of the aircraft, an aircraft comprises an auxiliary power unit. An auxiliary power is a jet power plant which operates in the same way as power plants which are intended for propulsion. The auxiliary power unit is designed to supply the onboard consumers of the aircraft. In particular, the auxiliary power unit is in operation when the power plants which are intended for propulsion are not running, but it can also be additionally in operation. The compressed air for the air conditioning system can be bled both from the auxiliary power unit and also from the power plants which are intended for propulsion. Since both the auxiliary power unit and also the power plants which are intended for propulsion can be responsible for the oily smell of the climatized air, it is advantageous if the method can be carried out on both the auxiliary power unit and also on the power plants which are intended for propulsion.

The compressor of a power plant comprises a plurality of compressor stages located one behind the other. The power plant bearings which are regularly responsible for oil leaks are located before the first stage of the compressor. The oil which escapes there, therefore, is contained within the whole airflow of the compressor from the first to the last stage of the compressor. For this reason, the secondary airflow can be bled from any stage of the compressor. Preferably, however, the secondary airflow is bled between the fourth and tenth stage of the compressor because in this region the compressed air for the air conditioning system is also bled.

The object relating to the device is achieved by providing a device measuring the oil content of a secondary airflow which is bled from a compressor of the power plant, a connecting device providing a connection to the inside of the compressor, and a gas line installed between the measuring device and the connecting device. Advantageous embodiments are found in the detailed description below.

According to the invention, the device comprises a measuring device for the oil content of a secondary airflow which is bled from the compressor of the power plant. The measuring device is connected to a connecting device by a gas line. The connecting device is designed for the creating of a connection to the inside of the compressor. The device is suitable for an application of the method as disclosed further herein.

As explained above, different openings are easily accessible in the wall of the compressor depending upon whether the power plant is installed or is located on a power plant test stand. The connecting device can be designed for connection to a borescope opening of the power plant, or for connection to a connection which is provided for the supply of an air conditioning system. The connection is created by the opening which is best accessible.

The measuring device can be designed so that the pressure of the secondary airflow during measuring may not exceed a determined value. The pressure at which the secondary airflow emerges from the compressor can lie above this value. For that reason, a pressure reducer can be installed in the gas line between connecting device and measuring device.

So as not to change the oil content of the secondary airflow, the pressure reducer is to be designed so that no oil settles on the component parts of the pressure reducer. This can be achieved by the part of the secondary airflow which is provided for measurement passing through to the pressure reducer on a straight path without changes of direction, and by the airflow flowing past as few component parts as possible during the passing through of the pressure reducer. For this purpose, the pressure reducer can have the following features: The pressure reducer can comprise a hollow housing, on the outer faces of which are arranged an inlet opening for the secondary airflow, and a plurality of outlet openings. One of the outlet openings, which is located preferably opposite the inlet opening, can be connected to the measuring device. Further outlet openings can act as overflow openings and be intended for the discharge of surplus air to the environment. For establishing of the pressure, the overflow openings can be individually closable.

The pressure reducer, furthermore, ensures that the air always remains in motion. A stationary state of the air would lead to a depositing of the particles.

In order to be able to keep also the volumetric flow rate constant during measuring, in addition to the pressure, the device can comprise a volumetric flow rate controller. So that the volumetric flow rate controller is subjected to a secondary flow at constant pressure, the volumetric flow rate controller is installed preferably after the pressure reducer.

Owing to a depositing of the oil on component parts, the volumetric flow rate controller can also bring about a change of the oil content of the secondary airflow. In order to avoid an impairment of the measurement, the volumetric flow rate controller can be installed after the measuring device.

Also, in emergency cases, it should be possible to interrupt the secondary airflow which is branched from the compressor. For this purpose, a solenoid valve can be installed in the gas line between connecting device and measuring device, which closes the gas line as soon as it is isolated from the power supply.

The measuring device for the oil content of the secondary airflow can be an aerosol spectrometer.

The device can be designed for carrying out the measurement on a power plant test stand. It can also be designed, however, so that it is usable on the installed power plant. This is especially on the assumption that the device can be transported by suitable means on the airfield and that the gas line is long enough to create the connection to the installed power plant.

### BRIEF DESCRIPTION OF THE DRAWINGS

On the basis of an advantageous embodiment, the invention is subsequently exemplarily described, with reference to the accompanying drawings. In the drawings:

FIG. 1 shows a section through the compressor of an aviation jet power plant;

FIG. 2 shows a schematic view of the device according to the invention;

FIG. 3 shows a section through a pressure reducer according to the invention;

FIG. 4 shows a schematic view of the functioning method of an aerosol spectrometer; and

FIG. 5 shows a graphical representation of the results of a measurement according to the invention.

### DETAILED DESCRIPTION OF THE INVENTION

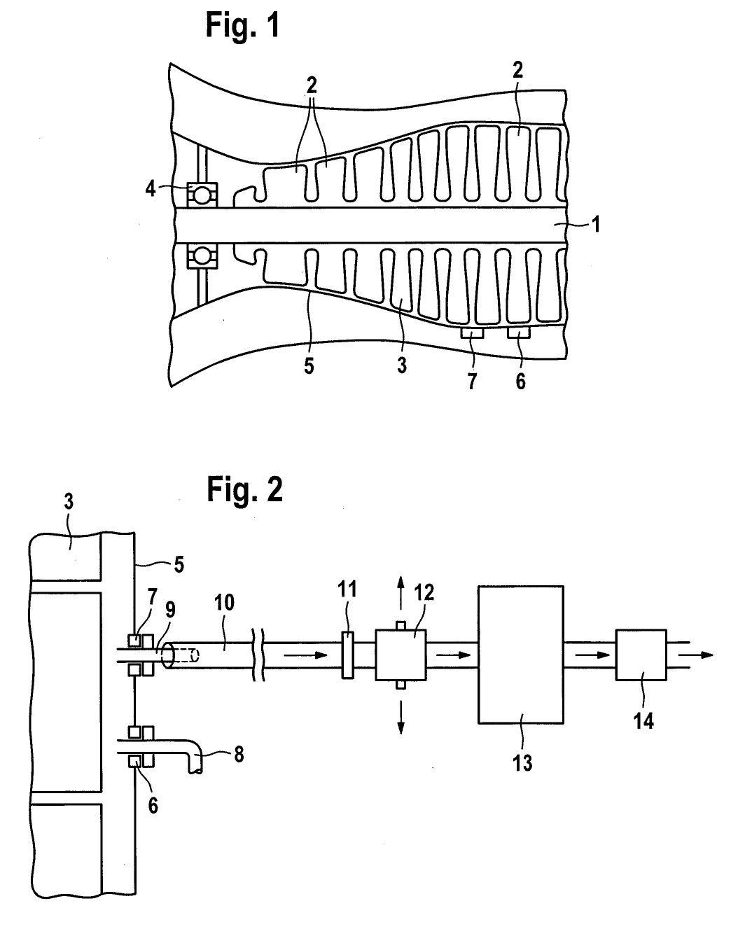

An aviation jet power plant, in addition to the combustion chamber, turbine, propulsive nozzle, all of which are not shown, comprises a compressor, which is shown in FIG. 1. The compressor has the task of compressing the ambient air which is supplied for combustion. In the compressor, a plurality of compressor stages 2 are arranged in series one behind the other in the axial direction on a shaft 1 of the power plant. Each stage of the compressor comprises an impeller 3 which is rigidly connected to the shaft 1, which impeller receives the air from the preceding stage of the compressor, compresses it further, and transfers it to the next stage of the compressor. Before the compressor, the shaft 1 is mounted by a bearing 4. A connection 6 for the bleed of compressed air for an air conditioning system, and a borescope opening 7 for inspecting of the inside of the compressor by means of a borescope, are arranged in the wall 5 which encloses the compressor. In the region of the borescope opening 7, the air in the compressor is under a pressure of 8-13 bar, and has a temperature of 350°.

If, on account of faulty sealing, oil escapes from the bearing 4, so this oil mixes with the airflow in the compressor. By means of the impellers 3, the oil is distributed evenly in the airflow and the compressed air which is bled at the connection 6 for the supply of the air conditioning system has an oily smell.

The wall 5 of the compressor with the connection 6 and the borescope opening 7 are found again in the schematic view of FIG. 2. In the installed state of the power plant, a compressed air line 8 for the supply of the air conditioning system is connected to the connection 6. The borescope opening 7 is closed by a cover in normal operation. For carrying out measurement, the cover was removed and replaced by a-connecting device 9. A gas line 10 is fitted onto the connecting device 9, by which some of the airflow of the compressor is branched as secondary airflow. The secondary airflow is directed to an aerosol spectrometer 13 by means of a solenoid valve 11 and a pressure reducer 12. A volumetric flow rate controller 14 is installed after the aerosol spectrometer 13.

If the power plant is located on a power plant test stand then the pressure line 8 for the air conditioning system was removed beforehand during disassembly. In this case, the connecting device 9 can be connected to the connection 6, and the borescope opening 7 can be closed by a cover.

The functioning method of the aerosol spectrometer 13 is shown schematically in FIG. 4. The secondary airflow, the oil content of which is to be checked, flows perpendicularly to the plane of the drawing and brings along with it a plurality of oil particles 15. A light beam 16 passes across the secondary airflow. The effect of the light beam being strictly spatially delimited is achieved by a diaphragm 17. If the light beam 16 strikes a particle 15, then it is reflected on the surface of the particle. A part of the reflected light is directed onto a photomultiplier 19 through an orifice in a diaphragm 18.

From the intensity and distribution of the light which is recorded by the photomultiplier 19, a conclusion can be reached regarding the number and size of the particles 15 which are contained in the measuring volume 20 which is defined by the diaphragms 17 and 18.

The secondary flow which emerges through the borescope opening 7 is under such high pressure, and has such a high temperature, that the aerosol spectrometer 13 cannot directly process the secondary flow. For reducing of the pressure of the secondary flow, a pressure reducer 12 is installed in the gas line 10 before the aerosol spectrometer 13 for that reason.

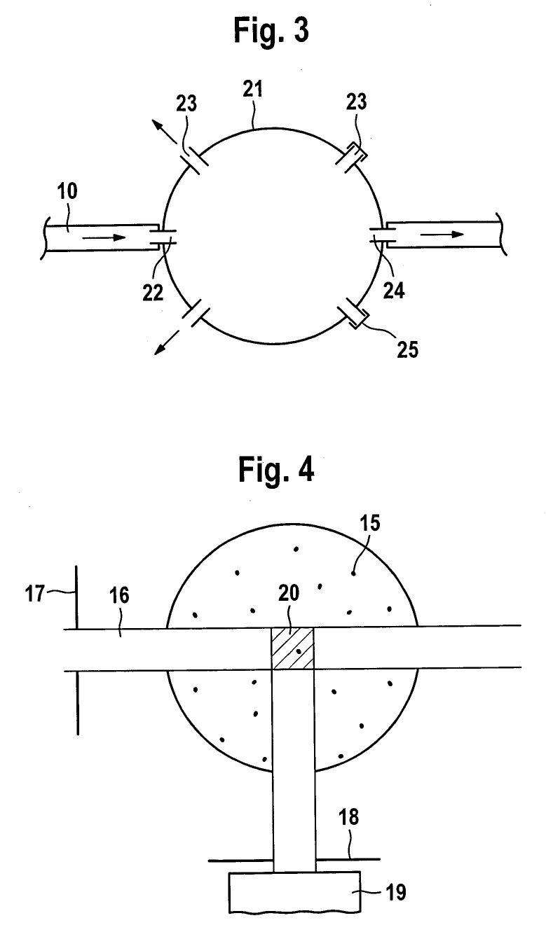

According to FIG. 3, the pressure reducer has a cylindrical housing 21 with one inlet opening 22 and five outlet openings 23,24. By the inlet opening 22, the pressure reducer 12 is connected to the borescope opening 7. One outlet opening 24 is located in the housing opposite the inlet opening 22, which outlet opening creates a connection to the aerosol spectrometer 13. By further outlet openings 23, which act as overflow openings, some of the secondary flow escapes to the environment. The pressure of the secondary flow in the pressure reducer 12 drops, at the same time the temperature of the secondary flow reduces as a result of expansion. Some of the secondary flow gets through the outlet opening 24 to the aerosol spectrometer 13 at noticeably reduced pressure and noticeably reduced temperature. The overflow openings 23 can be individually closed by caps 25 for establishing of the pressure.

The pressure reducer 12 is designed so that the part of the secondary flow which is used for measuring is not deflected inside the pressure reducer 12. By this, the effect can be achieved of the aerosol content of the secondary flow remaining almost constant during the passing through of the pressure reducer since only a small deposit of the particles 15 of the aerosol on the component parts of the pressure reducer occurs. By means of the overflow openings 23, the secondary flow remains in motion even if no part of the secondary flow flows through the measuring device. Also, the constant movement of the secondary flow contributes to the aerosol not being deposited.

In addition to a constant pressure, it is necessary for the comparability of different measurements that the volumetric flow rate through the measuring volume 20 is also constant. For this purpose, the volumetric flow rate controller 14 is installed after the aerosol spectrometer 13. A pump is expediently used as the volumetric flow rate controller 14, which pump keeps the volumetric flow rate constant even during pressure fluctuations. Also, some of the aerosol can be deposited in the volumetric flow rate controller 14. In order that, the measuring is not impaired by this, the volumetric flow rate controller 14 is installed after the aerosol spectrometer 13.

The solenoid valve 11 closes the gas line 10 as soon as it is isolated from the power supply.

The implementation of the method according to the invention by means of the described device is subsequently exemplarily described on the basis of a measuring on a power plant on the power plant test stand.

The power plant, which is removed from the aircraft, is installed in the power plant test stand and connected to a fuel supply and to a control unit. The connecting device 9 is attached to the connection 6 for the supply of the air conditioning system, which is located at the seventh stage of the compressor, and the gas line 10 is fitted.

For measuring, the power plant is brought to a speed of up to 5000 RPM (take-off speed). In this operating state, the pressure of the airflow in the seventh stage of the compressor amounts to 9 bar, and the temperature 300° C.

The secondary flow which is branched off by the connecting device 9 reaches the pressure reducer 12 through the gas line 10. At all four overflow openings 23 the caps 25 are removed, all four overflow openings 23 are used for pressure reduction and expansion of the secondary flow. Inside the pressure reducer, the pressure of the secondary flow reduces to 2 bar and the temperature reduces to 100° C.

The volumetric flow rate controller 14 is set at a constant volumetric flow rate of 5/min. Through the outlet opening 24, therefore, a partial volumetric flow rate of the secondary flow of 5 l/min, at a pressure of 2 bar and with a temperature of 100° C., passes through to the aerosol spectrometer 12.

The diaphragms 17 and 18 are selected so that a measuring volume 20 of 100 mm³ results.

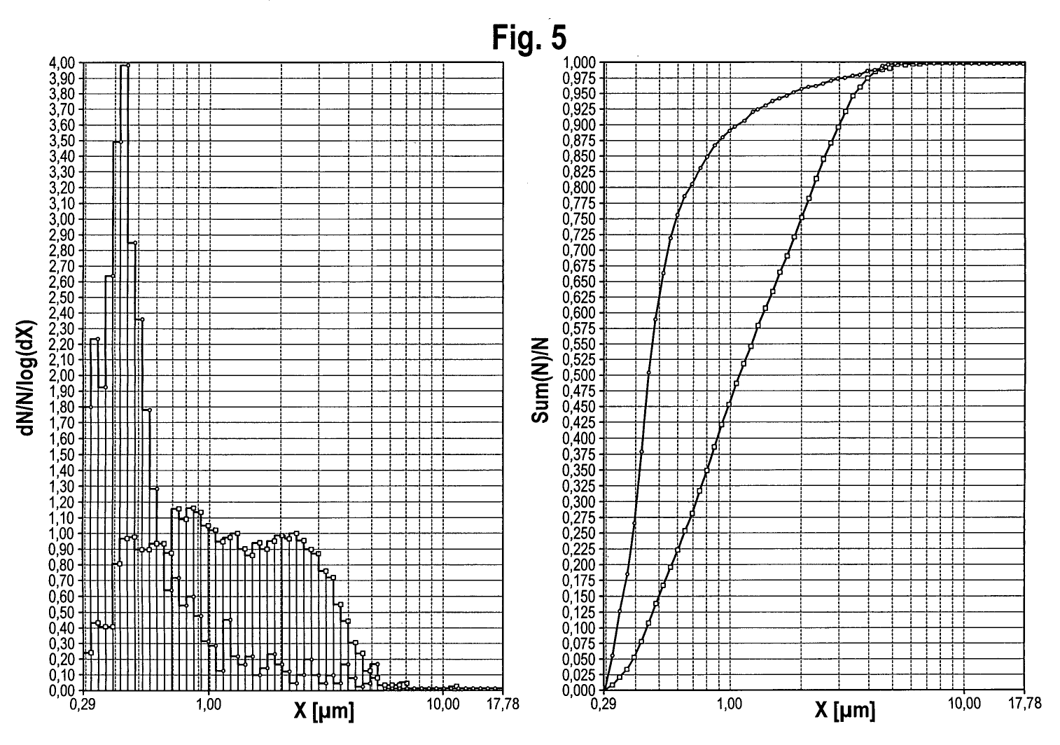

By an aerosol spectrometer WELAS 2000, from the firm of PALAS GmbH, of Karlsruhe, Germany, under these conditions the aerosol content of the air which flows through the measuring volume 20 is measured for a period of time of 1 minute. As a measurement result, the number of particles 15 in different size classes is obtained, as it is shown in FIG. 5. FIG. 5 shows a classification into ten size classes, wherein the particles in the smallest class have an average diameter of 0.178 μm, and the particles in the largest size class have an average diameter of 0.649 μm.

A first measuring is undertaken in which the compressor of the auxiliary power unit inducts normal room air. As FIG. 5 shows, the absolute number of detected particles is small and most of the particles lie in the 0.205 μm and 0.237 μm size classes.

During a second measuring, an aerosol generator is installed before the induction opening of the compressor, and the inducted air is enriched with an oil aerosol. During this measuring, a significantly larger number of particles is detected, and most of the particles lie in the 0.237 μm and 0.274 μm size classes. Furthermore, it is recognized that the size distribution of the particles in air which is contaminated with oil deposits is significantly wider, and substantially higher particle frequencies occur in the respective size classes. The distribution patterns differ very noticeably from each other.

These differences make it possible to distinguish air which is contaminated with oil deposits from air which is not contaminated.

If particles of other substances, for example aluminium particles from abrasion of the component parts of the compressor, are contained in the airflow of the compressor, these can be distinguished from oil particles on account of their different density on the basis of the mass concentration in the measuring volume.

1-37. (canceled)

38. A method for checking an aviation jet power plant for oil leaks, comprising inspecting for oil deposits a secondary airflow which is bled from a compressor of the power plant.

39. The method of claim 38, further comprising measuring an aerosol content of the secondary airflow.

40. The method of claim 39, comprising determining numbers of particles within different size classes.

41. The method of claim 40, wherein the size classes comprise particles with a diameter of between 0.05 μm and 10 μm.

42. The method of claim 41, wherein the size classes are between 0.1 μm and 5 μm.

43. The method of claim 41, wherein the size classes are between 0.2 μm and 2 μm.

44. The method of claim 39, wherein the aerosol content is measured on the basis of the dispersion of white light on particles inside a measuring volume.

45. The method of claim 39, wherein the aerosol content is determined by means of an aerosol spectrometer.

46. The method of claim 39, 44 or 45, comprising determining a mass concentration of the particles inside the aerosol.

47. The method of claim 39, 40, 44 or 45, comprising reducing a pressure of the secondary airflow before measuring.

48. The method of claim 45, comprising discharging some of the secondary airflowy to the environment before measuring.

49. The method of claim 45, wherein the measuring is carried out at constant pressure of the air which is to be inspected.

50. The method of claim 47, wherein the pressure during the measuring lies between 2 bar and 15 bar.

51. The method of claim 47, wherein the pressure during the measuring lies between 5 bar and 10 bar.

52. The method of claim 47, wherein the pressure during the measuring lies between 7 bar and 9 bar

53. The method of claim 39, wherein the measuring is carried out at a constant volumetric flow rate.

54. The method of claim 53, wherein the volumetric flow rate lies between 0.5 l/min and 20 l/min.

55. The method of claim 39, wherein a temperature during the measuring lies between 50° C. and 150° C.

56. The method of claim 38 or 39, wherein the method is carried out on a power plant test stand.

57. The method of claim 38 or 39, wherein the method is carried out with the power plant installed.

58. The method of claim 38 or 39, wherein the secondary airflow is bled through a borescope opening of the power plant.

59. The method of claim 38 or 39, wherein the secondary airflow is bled through a connection which is provided for the supply of the air conditioning system.

60. The method of claim 38 or 39, wherein the secondary airflow is bled between the 7^{th} and 10^{th} stage of an aviation engine compressor.

61. An apparatus for checking an aviation jet power plant for oil leaks, comprising:
a device measuring the oil content of a secondary airflow which is bled from a compressor of the power plant,
a connecting device providing a connection to the inside of the compressor, and
a gas line installed between the measuring device and the connecting device.

62. The apparatus of claim 61, wherein that the connecting device is configured for connection to a borescope opening of the power plant.

63. The apparatus of claim 61, wherein the connecting device is configured for connection to a connection which is provided for the supply of an air conditioning system.

64. The apparatus of claim 61, further comprising a pressure reducer installed in the gas line between connecting device and measuring device.

65. The apparatus of claim 64, wherein the pressure reducer comprises a housing with inlet and outlet openings for the air, and the housing is hollow inside.

66. The apparatus of claim 65, wherein the housing has a cylindrical shape, and that the inlet and outlet openings are arranged on external faces of the cylinder.

67. The apparatus of claim 65 or 66, wherein the pressure reducer comprises one inlet opening and a plurality of outlet openings.

68. The apparatus of claim 65 or 66, wherein one of the outlet openings is connected to the measuring device, and that this outlet opening is installed in the housing opposite the inlet opening.

69. The apparatus of claim 65 or 66, wherein some of the outlet openings are overflow openings for discharge of surplus air to the environment.

70. The apparatus of claim 69, wherein the overflow openings are individually closable.

71. The apparatus of claim 61, further comprising a volumetric flow rate controller for the secondary airflow.

72. The apparatus of claim 71, wherein the volumetric flow rate controller is installed after the pressure reducer.

73. The apparatus of claim 72, wherein the volumetric flow rate controller is installed after the measuring device.

74. The apparatus of claim 61, further comprising a solenoid valve installed in the gas line for closing the gas line in the case of interruption of the power supply.

75. The apparatus of claim 71, wherein the measuring device is an aerosol spectrometer.
